(19) United States
(12) Patent Application Publication
(10) Pub. No.: US 2021/0064836 A1
(43) Pub. Date: Mar. 4, 2021

(54) ELECTRONIC DEVICE

(71) Applicant: InnoLux Corporation, Miao-Li County (TW)

(72) Inventor: Ayumu MORI, Miao-Li County (TW)

(21) Appl. No.: 16/559,619

(22) Filed: Sep. 3, 2019

(51) Int. Cl. G06K 9/00; G02B 5/30; G06F 3/041; G02F 1/1335; G02F 1/1333

(52) U.S. Cl. CPC G06K 9/0004; G02B 5/3025; G06F 3/0412; G02F 1/13338; G02F 1/133528; G02F 1/133606; G06F 3/0416

(57) ABSTRACT

An electronic device is provided for optical fingerprint detection with high resolution. The electronic device includes a liquid crystal cell and a diffuser layer. The diffuser layer is disposed on the liquid crystal cell, and the diffuser layer is attached to the liquid crystal cell.

### BACKGROUND OF THE DISCLOSURE

### 1. Field of the Disclosure

The present disclosure relates to an electronic device, and more particularly, to an electronic device for optical fingerprint detection.

### 2. Description of the Prior Art

Electronic devices have become indispensable necessities to modern people no matter in their work, study or entertainment. With a flourishing development of the portable electronic devices, the consumers pursue better electronic characteristics such as higher quality, higher speed of response, longer life span or higher reliability, or have higher expects on the functions of the products to be more diversified. Therefore, developing or improving electronic devices are required.

### SUMMARY OF THE DISCLOSURE

The present disclosure provides an electronic device for optical fingerprint detection. The electronic device includes a liquid crystal cell and a diffuser layer. The diffuser layer is disposed on the liquid crystal cell, and the diffuser layer is attached to the liquid crystal cell.

These and other objectives of the present disclosure will no doubt become obvious to those of ordinary skill in the art after reading the following detailed description of the embodiment that is illustrated in the various figures and drawings.

### BRIEF DESCRIPTION OF THE DRAWINGS

FIG. 1 is a schematic diagram illustrating a cross-sectional view of an electronic device for optical fingerprint detection according to the first embodiment of the present disclosure.

FIG. 2 is a schematic diagram illustrating a partial cross-sectional view of an electronic device for optical fingerprint detection according to the first variant of the first embodiment of the present disclosure.

FIG. 3 is a schematic diagram illustrating a partial cross-sectional view of an electronic device for optical fingerprint detection according to the second variant of the first embodiment of the present disclosure.

FIG. 4 is a schematic diagram illustrating a partial cross-sectional view of an electronic device for optical fingerprint detection according to FIG. 1 of the first embodiment of the present disclosure.

FIG. 5 is a schematic diagram illustrating a partial cross-sectional view of an electronic device for optical fingerprint detection according to the third variant of the first embodiment of the present disclosure.

FIG. 6 is a schematic diagram illustrating a partial top view of an electronic device 100 for optical fingerprint detection according to the first embodiment of the present disclosure.

FIG. 7 is a schematic diagram illustrating a partial cross-sectional view of an electronic device for optical fingerprint detection according to the second embodiment of the present disclosure.

FIG. 8 is a schematic diagram illustrating a partial cross-sectional view of an electronic device for optical fingerprint detection according to the second approach of the second embodiment of the present disclosure.

FIG. 9 is a schematic diagram illustrating a cross-sectional view of an electronic device for optical fingerprint detection according to the third embodiment of the present disclosure.

### DETAILED DESCRIPTION

The present disclosure may be understood by reference to the following detailed description, taken in conjunction with the drawings as described below. For purposes of illustrative clarity understood, various drawings of this disclosure show a portion of the electronic device, and certain elements in various drawings may not be drawn to scale. In addition, the number and dimension of each device shown in drawings are only illustrative and are not intended to limit the scope of the present disclosure.

Certain terms are used throughout the description and following claims to refer to particular components. As one skilled in the art will understand, electronic equipment manufacturers may refer to a component by different names. This document does not intend to distinguish between components that differ in name but not function. In the following description and in the claims, the terms “include”, “comprise” and “have” are used in an open-ended fashion, and thus should be interpreted to mean “include, but not limited to”.

When an element or layer is referred to as being “on” or “connected to” another element or layer, it can be directly on or directly connected to the other element or layer, or intervening elements or layers may be presented. In contrast, when an element is referred to as being “directly on” or “directly connected to” another element or layer, there are no intervening elements or layers presented.

The terms “about”, “substantially”, “equal”, or “same” generally mean within 20% of a given value or range, or mean within 10%, 5%, 3%, 2%, 1%, or 0.5% of a given value or range.

Although terms such as first, second, third, etc., may be used to describe diverse constituent elements, such constituent elements are not limited by the terms. The terms are used only to discriminate a constituent element from other constituent elements in the specification. The claims may not use the same terms, but instead may use the terms first, second, third, etc. with respect to the order in which an element is claimed. Accordingly, in the following description, a first constituent element may be a second constituent element in a claim.

The technical features in different embodiments described in the following can be replaced, recombined, or mixed with one another to constitute another embodiment without departing from the spirit of the present disclosure.

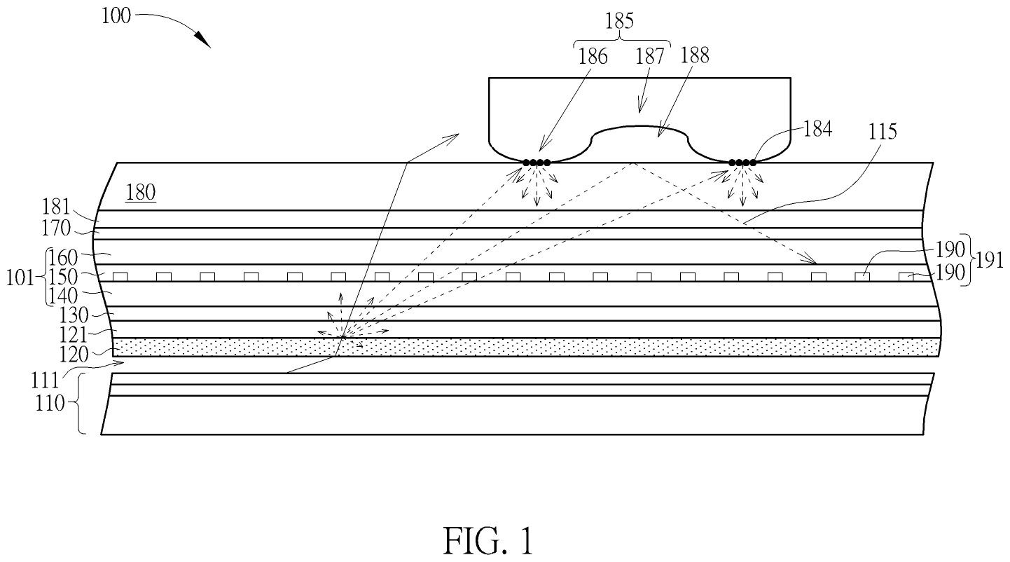

FIG. 1 is a schematic diagram illustrating a cross-sectional view of an electronic device 100 for use in the fingerprint detection according to the first embodiment of the present disclosure.

The electronic device 100 may include a backlight unit 110, a diffuser layer 120, an adhesive layer 121, a rear polarizing layer 130, a first substrate 140, a liquid crystal layer 150, a second substrate 160, a front polarizing layer 170, a protective layer 180, an adhesive layer 181 and an optical sensor 190 arranged in various positions. In some embodiments, at least one of the aforementioned elements may be omitted or replaced by other suitable elements. In some embodiments, multiple optical sensors 190 may further form an optical sensor array 191.

The electronic device 100 may include a display device, an antenna device, a sensor device, a lighting device, or a tiled device, but the present disclosure is not limited thereto. The electronic device 100 may be a foldable electronic device, a curvature electronic device, a free-shape electronic device or a flexible electronic device, but the present disclosure is not limited thereto. The electronic device 100 may include, for example, a liquid crystal (LC) molecules, a quantum-dot (QD), an organic light emitting diode (OLED), an inorganic light emitting diode (LED), such as a mini-LED or a micro-LED, a quantum-dot LED(QLED, QDLED), fluorescence, phosphor or other suitable materials, and the materials may be optionally combined, however, the disclosure is not limited thereto. The antenna device may be a liquid crystal antenna, but the present disclosure is not limited thereto. Please note that the electronic device 100 may be the optional combinations of the above, but the present disclosure is not limited thereto. A display device is given as an electronic device or a tiled device in the following descriptions, but the present disclosure is not limited thereto.

In the electronic device 100, the backlight unit 110 may be used to generate illumination. The backlight unit 110 may be disposed adjacent to the diffuser layer 120, and may include a light source, a light guide plate and/or an optical film, but the present disclosure is not limited to these. In one embodiment, the light guide plate may be omitted depending on the type of the backlight unit 110. In other embodiment (not shown), the backlight unit 110 may be omitted and the liquid crystal layer 150 may be changed to other medium or electronic unit comprising other materials.

A liquid crystal cell 101 may include the first substrate 140, the liquid crystal layer 150 and the second substrate 160. The liquid crystal cell 101 is disposed on the backlight unit 110. The liquid crystal layer 150 may be sealed between the first substrate 140 and the second substrate 150. The diffuser layer 120 may be disposed between the liquid crystal cell 101 and the backlight unit 110, and attached to an outer surface of the first substrate 140. For example, the diffuser layer 120 may be attached to the rear polarizing layer 130 in the electronic device 100.

For example, the diffuser layer 120 may be attached to the liquid crystal cell 101 through the adhesive layer 121. The rear polarizing layer 130 may be disposed between the liquid crystal cell 101 and the adhesive layer 121. The adhesive layer 121 and the adhesive layer 181 may include a material of a refractive index which is close to or substantially the same as that of the rear polarizing layer 130 or of the front polarizing layer 170. The adhesive layer 121 and the adhesive layer 181, for example, may be an optically clear adhesive (OCA) or an optically clear resin (OCR).

The term “attached to” in this disclosure may refer to the attachment between two adjacent objects by using an adhesive material or other suitable materials. For example, the two adjacent objects may be connected in the absence of an air gap, but not limited thereto. In one example, the diffuser layer 120 may be adhesive, and the adhesive material or other suitable materials may be omitted. In some examples, other elements, such as an adhesive or a polarizing film, may be disposed between the two adjacent objects in the absence of an air gap. For example, the diffuser layer 120 may be attached to an outer surface of the first substrate 140 in the absence of an air gap, while the rear polarizing layer 130 and the adhesive layer 121 are disposed between the diffuser layer 120 and the outer surface of the first substrate 14.

There may be a backlight air gap 111 disposed between the backlight unit 110 and the diffuser layer 120 so the diffuser layer 120 is not attached to the backlight unit 110 because of the backlight air gap 111. The diffuser layer 120 may be useful in providing incident light with relatively larger incidence angle. Incident light with relatively larger incidence angle may be advantageous to form total reflection light 115 in the protective layer 180 to enhance the image contrast of an object 185 (such as a fingerprint of a finger). The configuration of the present disclosure may enable the creation of strong or sharp total reflection from user's fingerprint pattern.

The first substrate 140 and the second substrate 160, for example, may respectively include a glass substrate, a polymer substrate, a ceramic substrate, other suitable substrates, or a combination thereof, but is not limited thereto. The liquid crystal cell 101 may include various elements. For example, the liquid crystal cell 101 may include thin film transistors, circuits electrically connected to the thin film transistors, color filters, a light shielding layer and the optical sensors 190. The liquid crystal cell 101 may include a plurality of pixels. In some examples, one pixel may include at least one optical sensor 190.

The front polarizing layer 170 may be disposed between the liquid crystal cell 101 and the adhesive layer 181. The protective layer 180 may be adhered to the front polarizing layer 170 through the adhesive layer 181 to protect the electronic device 100. The refractive index of the protective layer 180 may be associated with the critical angle of the total reflection in the present disclosure.

As shown in FIG. 1, the fingerprint 185 may include a plurality of fingerprint ridges 186 and fingerprint valleys 187. The fingerprint ridges 186 may be in direct contact with the protective layer 180, and the fingerprint valleys 187 may not be indirect contact with the protective layer 180 due to the air interface 188. The air interface 188 may induce total reflection. For example, if the refractive index of the protective layer 180 is 1.5 and the refractive index of air is 1, the critical angle of the total reflection may be about 42° (n=1.0/1.5), but not limited thereto. However, the moisture 184 or the like may be partially disposed between the fingerprint ridges 186 and the protective layer 180 due to the direct contact, so the total reflection may not exist at the fingerprint ridges 186. Accordingly, because the fingerprint ridges 186 may not induce the total reflection while the fingerprint valleys 187 may induce the reflection light 115, it is feasible to obtain a clear fingerprint image of high resolution, high sensitivity, or high image contrast (e.g., ridge may correspond to dark, valley may correspond to bright). In other words, the optical sensors 190 may detect the total reflection light 115 from the air interface 188 at fingerprint valley 187.

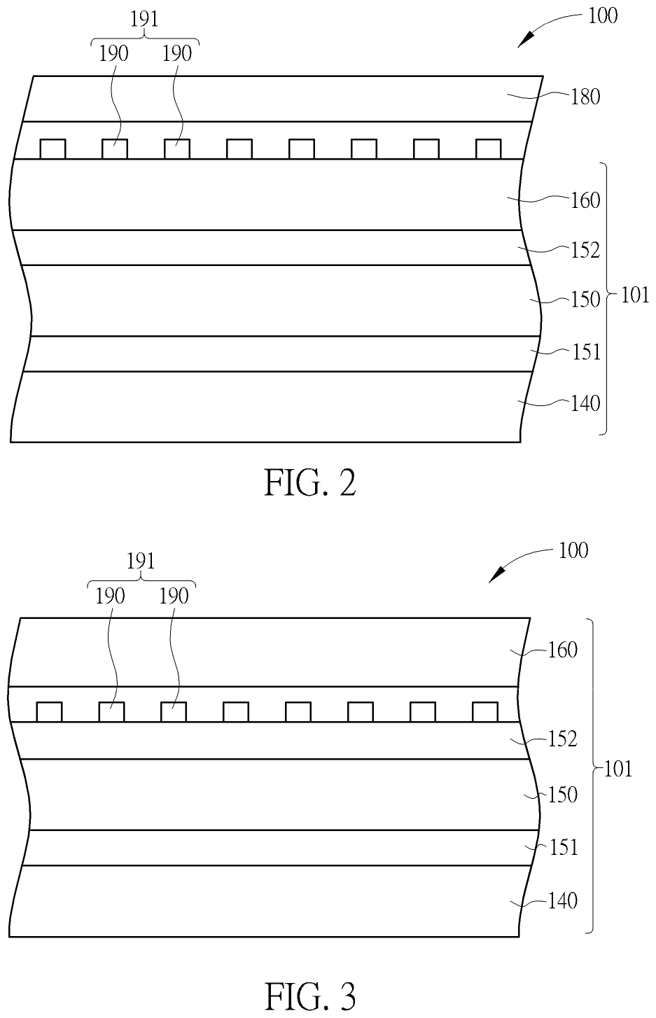

FIG. 2 is a schematic diagram illustrating a partial cross-sectional view of an electronic device 100 for use in optical fingerprint detection according to the first variant of the first embodiment of the present disclosure. In the first variant of the first embodiment of the present disclosure, an optical sensor array 191 including a plurality of optical sensors 190 may be disposed on the outer surface of the second substrate 160 to define an out-cell optical sensor structure. The optical sensor array 191 may be disposed between the protection layer 180 and the second substrate 160 of the liquid crystal cell 101. The liquid crystal cell 101 may include the first substrate 140, the liquid crystal layer 150, the thin film transistor (TFT) layer 151, the color filter layer 152 and the second substrate 160. The liquid crystal layer 150 may be disposed between the thin film transistor layer 151 and the color filter layer 152. This variant provides a shorter distance of the light from the protection layer 180 to the optical sensors 190, and the optical sensors 190 may receive stronger total reflection signals.

FIG. 3 is a schematic diagram illustrating a partial cross-sectional view of an electronic device 100 for use in optical fingerprint detection according to the second variant of the first embodiment of the present disclosure. In the second variant of the first embodiment of the present disclosure, the optical sensor array 191 including the optical sensors 190 may be disposed between the first substrate 140 and the second substrate 160 to define an in-cell optical sensor structure. In one example (not shown), the optical sensor array 191 may be disposed between the color filter layer 152 and the second substrate 160. In other examples (not shown), the optical sensor array 191 may be disposed between the liquid crystal layer 150 and the thin film transistor layer 151.

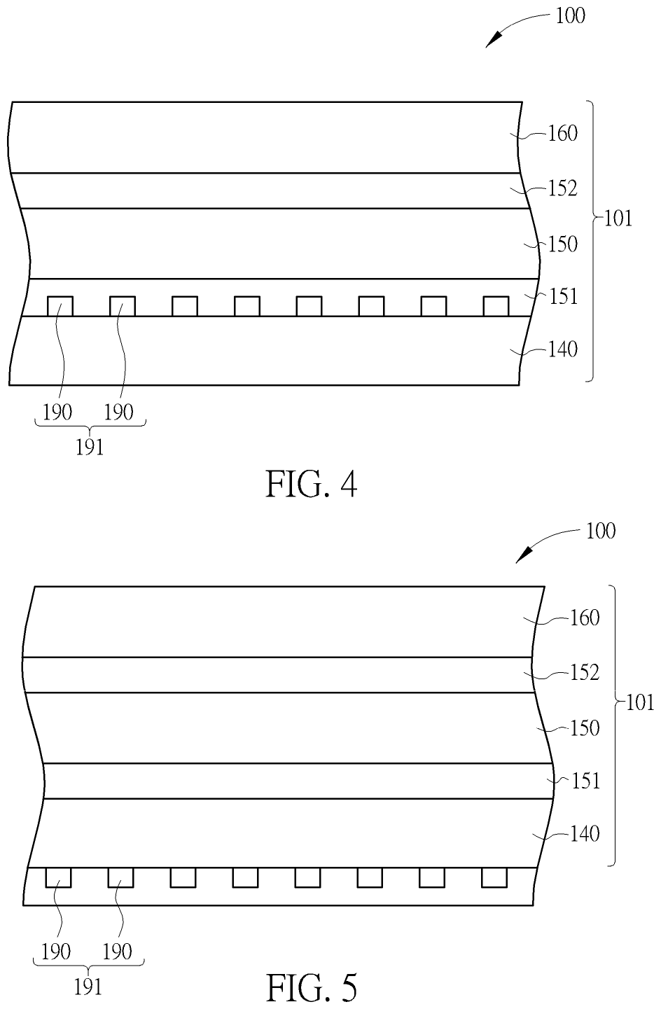

FIG. 4 is a schematic diagram illustrating a partial cross-sectional view of an electronic device 100 for use in optical fingerprint detection according to FIG. 1 of the first embodiment of the present disclosure. In FIG. 4, the optical sensor array 191 including the optical sensors 190 may be disposed on the inner surface of the first substrate 140 to define another in-cell optical sensor structure. Because the thin film transistor layer 151 is disposed on the inner surface of the first substrate 140 as well, it is possible that the optical sensors 190 and the thin film transistor layer 151 are in the same layer, but it is not limited thereto. The optical sensors 190 and the thin film transistor layer 151 may share a common electrode, but it is not limited thereto.

FIG. 5 is a schematic diagram illustrating a partial cross-sectional view of an electronic device 100 for use in optical fingerprint detection according to the third variant of the first embodiment of the present disclosure. In the fourth variant of the first embodiment of the present disclosure, the optical sensors 190 may be disposed on the outer surface of the first substrate 140 to define another out-cell optical sensor structure. The optical sensor array 191 may be disposed on the outer surface of the first substrate 140 of the liquid crystal cell 101.

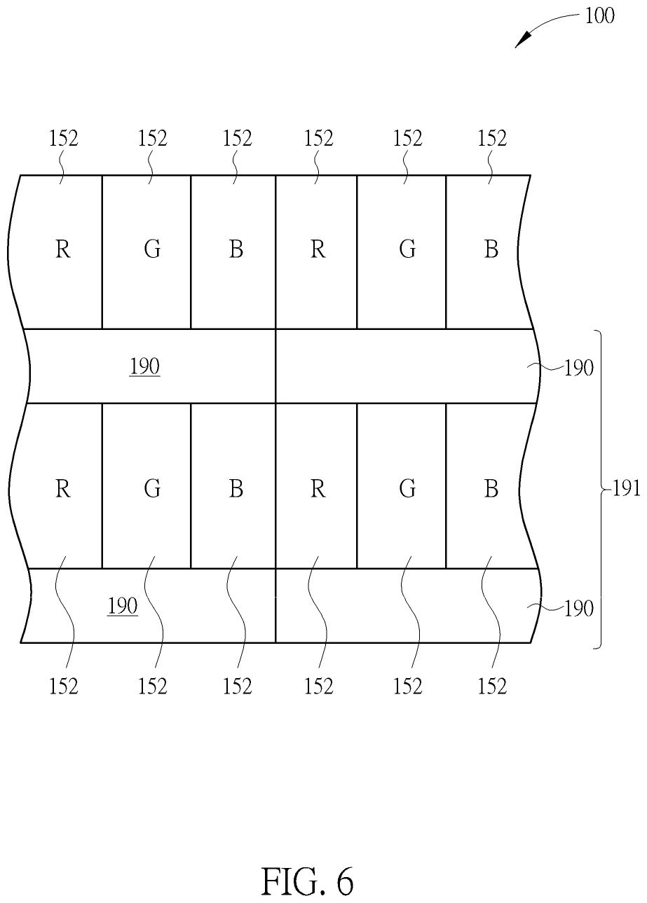

FIG. 6 is a schematic diagram illustrating a partial top view of an electronic device 100 for use in optical fingerprint detection according to the first embodiment of the present disclosure. FIG. 6 illustrates the arrangement of the optical sensors 190 respect to the color filters 152.

In the above variants, the optical sensors 190 and the color filters 152 may not be arranged in the same layer. However, from the top view, the optical sensors 190 may be arranged between the color filters 152, and the color filters 152 may be arranged between the optical sensors 190 as well. In one example, at least a portion of one optical sensor 190 does not overlap with the color filters 152. This arrangement may decrease the influence of the light signals from the total reflection by the color filters 152 to improve intensity or quality of the light signals.

The second embodiment of the present disclosure further introduces the adjustment of the haze value of the diffuser layer 120 to enhance the image contrast. The present disclosure proposes the adjustment of the haze value of the diffuser layer 120. The adjustment of the haze value of the diffuser layer 120 may enhance the image contrast.

In one embodiment, the haze value may be measured as the percentage of transmitted light scattered by more than 2.5° through the plastic specimen. The haze value is usually expressed in percentage (%).

For example, in the same electronic device 100, the change of the haze value of the diffuser layer 120 may affect the resolution, the sensitivity or the image contrast, so the adjustment of the haze value of the diffuser layer 120 may optimize the sensitivity, the resolution, or the image contrast. Table 1 shows that examples of different haze values of the diffuser layer 120 result in different contrasts.

TABLE 1

| Example | Haze value (%) | contrast |
|---|---|---|
| 1 | 0 | 2% |
| 2 | 20 | 2.2% |
| 3 | 50 | 5% |
| 4 | 80 | 9.3% |

Note:
(1) Contrast = (intensity of the total reflection of the light)/(intensity of the incident light)
(2) The critical angle in the examples is 42° and the contrasts are measured at 42° ± 2°.
(3) Haze value 0 represents the absence of a diffuser.

The above examples suggest that contrast is greater than 5% when the haze value is greater than 50%. The diffuser layer 120 of a haze value 80% may result in a sharp or strong reflection peak around the critical angle at 42°±2°. The improvement of the contrast may achieve good spatial resolution of fingerprint image without the need of any additional optical elements, such as collimator, pinhole, or lens. To facilitate the practice of the present disclosure, the haze value may be less than 90%.

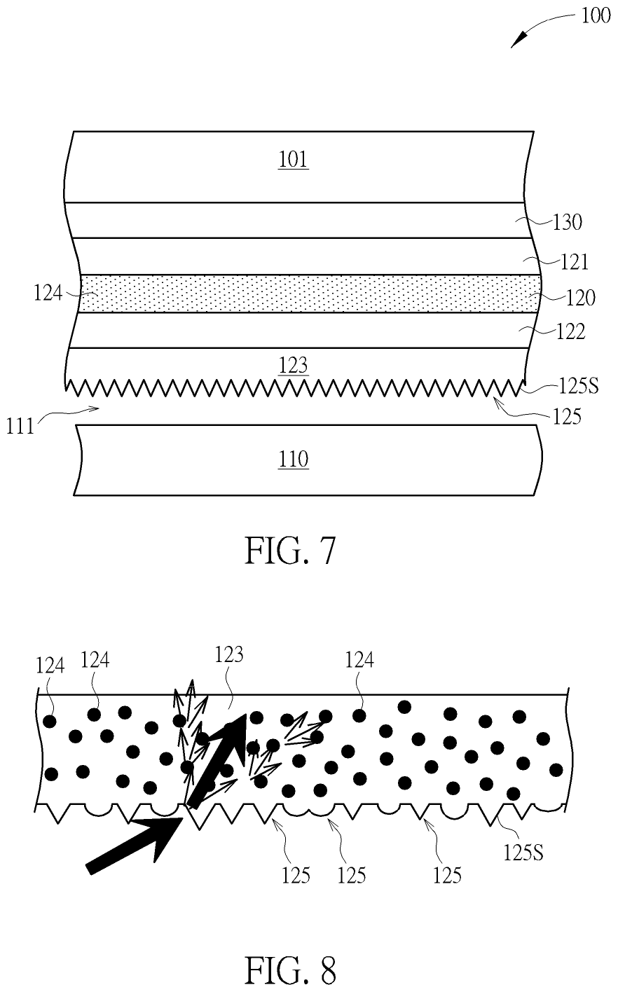

FIG. 7 is a schematic diagram illustrating a partial cross-sectional view of an electronic device 100 for use in optical fingerprint detection according to the second embodiment of the present disclosure. The second embodiment of the present disclosure proposes the adjustment of the haze value of the diffuser layer 120. The second embodiment of the present disclosure further proposes the use of a cover layer 122 or an outer indent layer 123. The cover layer 122 and/or the outer indent layer 123 may be optional depending on the needs.

The adjustment of the haze value of the diffuser layer 120 may be possible by two different approaches. The first approach proposes the introduction of materials 124 having different refractive indexes. The materials 124 of different refractive indexes may be introduced into the diffuser layer 120 or to an optional binding layer. In one example, the optional binding layer may be the adhesive layer 121. The material of the binding layer may include resin, glass, ceramics, cellulose, or other suitable materials to form films, plates, pastes, or glue.

The materials 124 having different refractive indexes may include particles, pigments, or air bubbles. The materials 124 may be dispersed in the diffuser layer 120 or in the optional binding layer. The size of one of the materials 124 may be in a range from 0.2 micrometer (μm) to 3 μm (0.2 μm≤size≤3 μm). The refractive index of the materials 124 may be less or greater than the refractive index of the diffuser layer 120. The refractive index of the materials 124 may be less or greater than the refractive index of the adhesive layer 121. The content of the materials 124 having different refractive indexes dispersed in the diffuser layer 120 and/or the binding layer may be adjusted to obtain an optimized range of the haze value of the diffuser layer 120 and/or the binding layer.

FIG. 8 is a schematic diagram illustrating a partial cross-sectional view of an electronic device 100 for use in optical fingerprint detection according to the second approach of the second embodiment of the present disclosure. Referring to FIGS. 7 and 8, the second approach proposes the introduction of an outer indent layer 123. The outer indent layer 123 may have an outer indented surface 125S. The outer indent layer 123 may be connected to the diffuser layer 120 through the cover layer 122. The outer indented surface 125S may have a patterned indented surface, a random indented surface or the combination thereof. The surface indent 125 may be formed by a method including frosted glass treatment, anti-glare treatment, blast finishing, or other suitable methods. The shapes of the surface indent 125 may include a curved shape, a prism shape, a micro-lens shape, other suitable shapes, or a combination thereof. In another variant of the present disclosure, the above two approaches may optionally be used solely or combined.

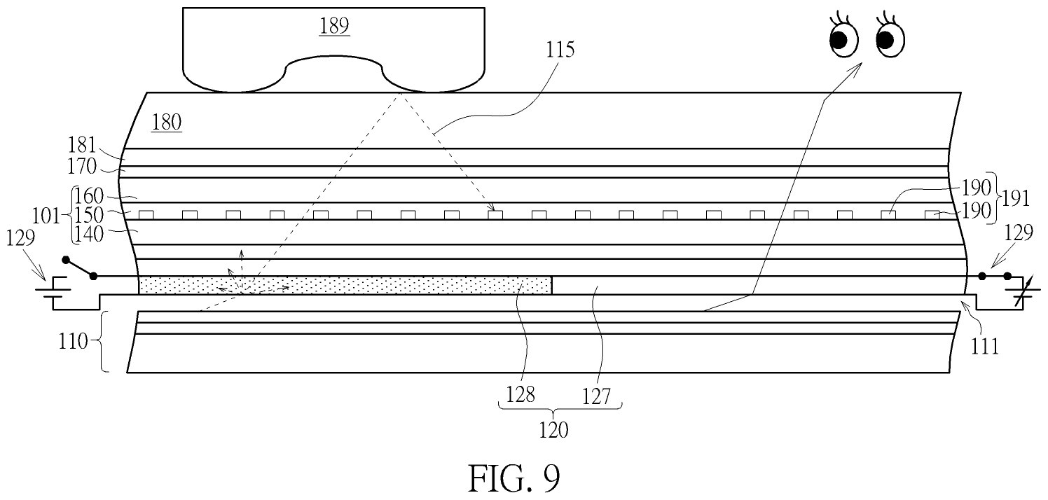

FIG. 9 is a schematic diagram illustrating a cross-sectional view of an electronic device 100 for use in optical fingerprint detection according to the third embodiment of the present disclosure. The third embodiment of the present disclosure proposes the adjustment of the haze value of the diffuser layer 120 by a switchable device 129. In other words, the switchable device 129 may include a control unit for controlling a haze value of the diffuser layer 120. The haze value of the diffuser layer 120 may be entirely or regionally controlled in the third embodiment.

In one embodiment, the diffuser layer 120 may include a haze adjustable layer. The haze adjustable layer may include a liquid crystal layer having polymer dispersed therein. For example, the haze adjustable layer may include a polymer dispersed liquid crystal (PDLC) layer, a polymer network liquid crystal (PNCC) layer, a polymer-stabilized liquid crystal (PSLC) layer, other suitable haze adjustable layers, or a combination thereof. The haze adjustable layer may be electrically connected to a switchable device 129. The switchable device 129 may be disposed on one side of the liquid crystal cell 101. The switchable device 129 may include a thin film transistor layer.

In the fingerprint detection mode for fingerprint sensing, the control unit may individually control different portions of the diffuser layer 120, and a first portion 127 of the diffuser layer 120 may have a first haze value and a second portion 128 of the diffuser layer 120 may have a second haze value. The second portion 128 may be for use in fingerprint sensing, and the second haze value may be greater than the first haze value.

In other words, the second portion 128 may be at least a partial region of the diffuser layer 120 for use in fingerprint sensing of the fingerprint detection mode. The fingerprint detection mode may refer to the use of the optical sensor array 191 for the detection of a user's fingerprint or another object.

The diffuse state of the second portion 128 of the diffuser layer 120 may be adjusted to the second haze value, for example, maybe greater than 50%, to facilitate better image contrast, and in such case the backlight unit 110 may be in a relatively brighter state. Other regions not in use of fingerprint sensing (e.g., the first portion 127) may be regionally controlled and adjusted to a relatively low haze value state, such as 0%, 10%, 20% or 40%, but not limited thereto. In other examples, when the electronic device 100 is not in the fingerprint detection mode, such as in a display mode, the diffuser layer 120 may be adjusted to a relatively low haze value state.

In other words, the brightness of the electronic may be comparable to other electronic device not having the diffusion layer 120. Although the brightness of the regional diffuse state for the fingerprint detection mode may be decreased, this may be only temporary and suitable for the fingerprint detection mode.

By controlling the haze value of the diffuser layer 120, contrast and sharpness of the total reflection light 115 may be changed as well, so the sensitivity or the spatial resolution of the optical sensor 190 may be greatly improved.

With the presence of the diffuser attached to the liquid crystal cell, the electronic device 100 of the present disclosure provides a good image contrast of the user's fingerprint in high image resolution. Further, the optical sensors 190 to receive the light from the total reflection may be arranged in different positions in accordance with various embodiments of the present disclosure.

In addition, the present disclosure also provides partial adjustment of the haze value of the diffuser by different approaches to enhance high resolution, high sensitivity or high image contrast in the absence of auxiliary optical elements. In such a way, a small fingerprint sensor can be embedded in a display module of an electronic device to serve as a cutting-edge technical breakthrough.

Those skilled in the art will readily observe that numerous modifications and alterations of the device and method may be made while retaining the teachings of the disclosure. Accordingly, the above disclosure should be construed as limited only by the metes and bounds of the appended claims.

1. An electronic device for optical fingerprint detection, comprising:
a liquid crystal cell comprising a plurality of color filters;
a diffuser layer disposed on the liquid crystal cell; and
an optical sensor array;
wherein the diffuser layer is attached to the liquid crystal cell, two adjacent color filters of the plurality of color filters exposes a portion of the optical sensor array, and the two adjacent color filters have same color.

2. The electronic device according to claim 1, further comprising a backlight unit disposed adjacent to the diffuser layer.

3. The electronic device according to claim 1, wherein a haze value of the diffuser layer is greater than 50%.

4. The electronic device according to claim 3, wherein the haze value of the diffuser layer is less than 90%.

5. The electronic device according to claim 1, wherein the diffuser layer comprises a polymer dispersed liquid crystal layer.

6. The electronic device according to claim 1, further comprising a control unit for controlling a haze value of the diffuser layer.

7. The electronic device according to claim 6, wherein the haze value is greater than 50% when the electronic device is in a fingerprint detection mode.

8. The electronic device according to claim 6, wherein the control unit controls a first portion of the diffuser layer to have a first haze value and controls a second portion of the diffuser layer to have a second haze value, and the second haze value is greater than the first haze value.

9. The electronic device according to claim 8, wherein the second haze value is greater than 50% when the electronic device is in a fingerprint detection mode.

10. The electronic device according to claim 1, wherein the liquid crystal cell comprises a first substrate, a second substrate, a liquid crystal layer sealed between the first substrate and the second substrate, and wherein the optical sensor array is disposed between the first substrate and the second substrate.

11. The electronic device according to claim 1, wherein the optical sensor array disposed between the diffuser and the liquid crystal cell.

12. The electronic device according to claim 1, further comprising a protection layer, wherein the optical sensor array is disposed between the protection layer and the liquid crystal cell.

13. The electronic device according to claim 2, further comprising an air gap disposed between the backlight unit and the diffuser layer.

14. The electronic device according to claim 10, wherein the optical sensor array forms an in-cell optical sensor structure.

15. The electronic device according to claim 1, further comprising an optical sensor array to form an out-cell optical sensor structure.

16. The electronic device according to claim 1, further comprising a plurality of thin film transistors and a plurality of optical sensors, and the plurality of thin film transistors and the plurality of optical sensors are in a same layer in the liquid crystal cell.

17. The electronic device according to claim 1, wherein the diffuser layer comprises a material which is dispersed in the diffuser layer to change a haze value of the diffuser layer.

18. The electronic device according to claim 1, further comprising an indent layer attached to the diffuser layer.

19. The electronic device according to claim 18, wherein the indent layer has an indented surface.

20. The electronic device according to claim 6, wherein the control unit is configured to regionally control the haze value of the diffuser layer.
